(19) United States
(12) Patent Application Publication
(10) Pub. No.: US 2014/0202172 A1
(43) Pub. Date: Jul. 24, 2014

(54) Cold Finger For Cryocoolers

(71) Applicant: SUNPOWER, INC., Athens, OH (US)

(72) Inventor: SeonYoung Kim, Athens, OH (US)

(73) Assignee: SUNPOWER, INC., Athens, OH (US)

(21) Appl. No.: 13/746,399

(22) Filed: Jan. 22, 2013

(51) Int. Cl. B23P 15/26; F25B 9/14

(52) U.S. Cl. CPC B23P 15/26; F25B 9/145
USPC 62/6; 29/890.035

(57) ABSTRACT

Method for fabricating a cold finger for attachment to a base assembly of a cold head of a Stirling cycle or pulse tube cryocooler. The exterior of a titanium alloy workpiece is machined to form a cylindrical outer surface. The exterior surface of the titanium workpiece is nickel plated and then brazed to a stainless steel workpiece to form an integral body. The brazed stainless steel workpiece is machined to form it into an adapter ring for attachment to the base assembly. An intermediate segment of the titanium workpiece is machined into a cylindrical surface including removing all of the nickel plating from the intermediate segment and removing a portion of underlying titanium alloy to reduce the diameter of the titanium alloy workpiece in order to reduce the thickness of the cold finger wall. The interior of the integral body is machined to form a cylindrical interior surface.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

This invention relates generally to Stirling cycle and pulse tube cryocoolers and more particularly relates to a method for manufacturing the cold finger of a cryocooler cold head and to a cold finger manufactured by the method. The method allows fabrication of a cold finger that utilizes the advantageous thermal conductivity of titanium alloy and allows a titanium cold finger to be formed with a thin wall but overcomes the problem of accomplishing the high precision coaxial alignment of such a cold finger with the displacer cylinder and the displacer connecting rod bore.

It is generally desirable to manufacture the cold head of a Stirling or pulse tube cryocooler with an outer casing of stainless steel. However, some component parts of a cryocooler are preferably made of other materials. For example, parts for which a high thermal conductivity is desired are often made of copper. Parts for which a low thermal conductivity is desirable have been made of titanium alloy. It is desirable that the cold finger has a low thermal conductivity because the conduction of heat longitudinally along a cold finger reduces operating efficiency. Unfortunately, the use of titanium to form the cold finger introduces both alignment problems and material joining problems into the fabrication of the cold head of a cryocooler.

The cold head of a Stirling cryocooler typically has a displacer that reciprocates in a displacer cylinder. A displacer connecting rod extends in one axial direction from the displacer through a cylindrical bore into connection with a mechanical spring. Extending in the opposite axial direction into the cold finger and reciprocating as part of the displacer is an extension of the displacer. The extension may house a regenerator material. The displacer, displacer rod and the extension of the displacer all reciprocate as a unit within respective cylinders; namely, the displacer cylinder, the displacer rod bore and the cold finger. It is important that the displacer and the displacer connecting rod have a very close tolerance, small clearance fit within their respective cylinders in order minimize working gas leakage through their clearance gaps. It is also important that the relatively long extension of the displacer, which extends into the cold finger, not rub against the interior surface of the cold finger. As a result, it is critical that the displacer rod bore, the displacer cylinder and the cold finger all have their cylindrical surfaces coaxially aligned with extraordinary precision along a common axis. The cold head and the theory of operation of a pulse tube cryocooler is quite similar to the cold head and the theory of operation of a Stirling cryocooler which is why the invention is applicable to both. The exterior structures of their cold fingers, which is what the present invention is applied to, are essentially the same, although their interior structures are different. The pulse tube cryocooler has no displacer or displacer rod because the volume displacement mechanism of the Stirling cycle displacer is replaced in a pulse tube cryocooler by an orifice opening to a surge volume. The theory of operation of both, as well as their similarities and differences, are well known to those skilled in the art.

Although titanium is the preferred material for forming the cold finger for the reasons explained above, titanium is difficult to weld, especially to something other than titanium. Although stainless steel is relatively easily welded to stainless steel, there is only one practical way to join titanium to stainless steel and that is by brazing. One option is that the titanium can be nickel plated and then brazed to stainless steel. An alternative option is that the brazing can be performed in a vacuum oven. However, the latter brazing requires a special oven which greatly increases the cost and performing this braze in a vacuum oven is currently considered to be very difficult to perform

These difficulties become amplified if a Stirling cryocooler is being designed and constructed as a low power cryocooler. For some cryocooler applications a low cooling power is required. In those applications, it is desirable to design the cryocooler to have only sufficient cooling capacity to meet the needs of the application because the cryocooler can be smaller and therefore have less weight, size and material. But a cryocooler that is smaller with less cooling capacity necessarily means that it parts, such as its displacer, the displacer cylinder and the cold finger will have a smaller diameter. But smaller diameter displacers require smaller clearance gaps between the reciprocating surfaces. The reason is that cryocooler efficiency is reduced by gas passage through the clearance gap. In particular, machine efficiency is a function of the ratio of the volume of working gas leakage to total working gas volume. The higher the ratio of working gas leakage volume to total working gas volume, the lower the machine efficiency. Because the entire working gas volume in a low cooling capacity cryocooler is smaller, and there are smaller volumes of expansion space and compression space, a smaller volume of leakage through the clearance gap is needed in order to maintain a practical efficiency. The working gas leakage through the clearance gap is reduced by reducing the size of the clearance gap. But the smaller clearance gap means a tighter closer fit. The tighter fit due to the smaller clearance gap makes coaxiality more difficult to attain but also makes coaxiality more critical.

In a similar manner, the problem of the reduction in efficiency caused by heat conduction longitudinally along the cold finger is also amplified for a low power cryocooler. Efficiency is a function of the ratio of thermal energy conducted along the outer cold finger wall to the total thermal lifting capacity of the cryocooler. As that ratio become larger, efficiency is reduced. Consequently, in order to maintain a practical efficiency on the order of the efficiency of cryocoolers with a larger cooling capacity, it is necessary to have less thermal conduction along the cold finger outer wall than can be tolerated with a larger capacity cryocooler. Heat conduction can be reduced by using a lower conductivity material such as titanium alloy for forming the cold finger and by reducing the thickness of outer wall of the cold finger. However, making the tubular cold finger thinner in order to reduce heat conduction makes the cold finger mechanically weaker. Therefore, the machining techniques becomes even more critical.

There is, therefore, a need to join a titanium cold finger tube to the cold finger base assembly in a way that is durable, is done with a material that will not cause outgassing that would contaminate the working gas and will form a joint that does not distort or deteriorate and thereby become misaligned in the cold head fabrication process so that the cold finger is coaxially aligned with the displacer cylinder and with the cylindrical bore for the displacer connecting rod despite the necessary smaller clearance gaps. That is necessary so that the entire displacer assembly is free to reciprocate without wear from friction and without friction against the cylindrical surfaces in which it reciprocates.

In view of all the above design criteria, it might be obvious that the way to fabricate a cold head with a titanium cold finger is to manufacture the titanium cold finger, nickel plate it and then braze it to the stainless steel casing of the cold head. However, the process of brazing titanium to stainless steel makes it very difficult to braze the titanium cold finger in a sufficiently precise physical orientation on the casing that the displacer rod bore, the displacer cylinder and the cold finger will have coaxiality with the necessary precision.

That method was attempted. However, the result was unsatisfactory because the coaxiality of the alignment of the cold finger with the stainless casing was not sufficiently precise. It is theorized that, when the nickel plated cold finger is brazed to stainless steel in the open air, the temperatures are not uniform so the resulting braze has irregular distortions that realign the parts from coaxiality. An attempt was also made to braze a titanium cold finger to a stainless steel casing in a vacuum oven in order to gain more uniform temperatures. But the oven introduced other difficulties which also led to a titanium cold finger brazed to a stainless casing with inadequate coaxiality.

Therefore, it is an object and feature of the present invention to provide a method for manufacturing a cold finger for a Stirling or pulse tube cryocooler so that the operable part of the cold finger is titanium but the cold finger can be joined to the casing of the cold head by welding and result in a cold finger that has sufficiently precise coaxiality.

### BRIEF SUMMARY OF THE INVENTION

The invention is principally a method for fabricating a cold finger for attachment to a base assembly of a cold head of a Stirling cycle or pulse tube cryocooler. In the invention, the exterior surface of a titanium alloy workpiece is machined to form a cylindrical outer surface on the titanium workpiece. At least an end portion of the exterior surface of the titanium workpiece is nickel plated. Preferably, the entire exterior surface is nickel plated which eliminates an otherwise troublesome masking process. The nickel plated end of the titanium workpiece is then brazed to a stainless steel workpiece. After joining the titanium workpiece and the stainless steel workpiece in this manner, the integrally joined workpieces are both machined as a unitary body. The brazed stainless steel workpiece is machined to form it into an adapter ring for attachment to a stainless steel base assembly.

An intermediate segment of the titanium workpiece is machined into a cylindrical surface including removing all of the nickel plating from the intermediate segment; and removing a portion of underlying titanium alloy to reduce the diameter of the titanium alloy workpiece in order to provide a reduced thickness wall of a cold finger tube. In the preferred embodiment, the initial titanium workpiece is a solid rod and, after joining the titanium workpiece with the stainless steel workpiece, the interior of the rod and the interior of the stainless steel workpiece is machined to form the cold finger tube with a cylindrical interior surface.

The invention also includes a cold finger that is fabricated according to the above method.

### BRIEF DESCRIPTION OF THE SEVERAL VIEWS OF THE DRAWINGS

FIG. 1 is a view in axial section taken substantially along the line 1-1 of FIG. 2 of a cold head embodying the present invention.

FIG. 2 is a left end view of the cold head of FIG. 1.

FIG. 3 is a left end view of a titanium workpiece fabricated according to the process of the invention and at an intermediate stage.

FIG. 4 is a side view of the titanium workpiece of FIG. 3.

FIG. 5 is a left end view of a stainless steel workpiece fabricated according to the process of the invention and at an intermediate stage.

FIG. 6 is a view in axial section of the stainless steel workpiece of FIG. 5 taken substantially along the line 6-6 of FIG. 7.

FIG. 7 is a right end view of the stainless steel workpiece of FIGS. 5 and 6.

FIG. 8 is a view in axial section of the titanium workpiece of FIGS. 3 and 4 joined to the stainless steel workpiece of FIGS. 5, 6 and 7 and taken along the line 6-6 of FIG. 7.

FIG. 9 is a view in axial section of the joined workpieces of FIG. 8 but further machined in accordance with the invention and is taken along the line 9-9 of FIG. 10.

FIG. 10 is a left end view of the joined workpieces of FIG. 9.

FIG. 11 is a left end view of a titanium workpiece fabricated in accordance with an alternative embodiment of the invention and at an intermediate stage.

FIG. 12 is a view in axial section of the titanium workpiece of FIG. 11 taken along the line 12-12 of FIG. 11.

FIG. 13 is a left end view of a stainless steel workpiece fabricated in accordance with an alternative embodiment of the invention.

FIG. 14 is a view in axial section of the stainless steel workpiece of FIG. 13 taken substantially along the line 14-14 of FIG. 13.

FIG. 15 is a side view of the titanium workpiece of FIGS. 11 and 12 joined to the stainless steel workpiece of FIGS. 13 and 14 and at an intermediate stage.

FIG. 16 is a view in axial section of the joined workpieces of FIG. 15 and taken along the line 16-16 of FIG. 15.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

As known in the prior art, Stirling cryocoolers are made in an integral configuration and in a split type configuration. The integral configuration has an integral wave generator and cold head so that there is a direct mechanical connection in the same casing between the wave generator and the cold head. The split type configuration has the cold head and the wave generator in separate casings with only a small tube, in which the working gas oscillates, connecting together the working gas space in each. In both configurations, the wave generator typically includes one or more pistons driven in reciprocation by an electric linear motor. Desirably, two pistons are driven in opposed reciprocation in order to minimize vibration by cancellation. The advantage of the split type configuration is that the vibrations of the wave generator are isolated from the cold head at both the fundamental operating frequency of the pistons and its harmonics. That isolation permits sensors to be mounted directly to the cold tip at the end of the cold finger without damage to the sensors from vibrations.

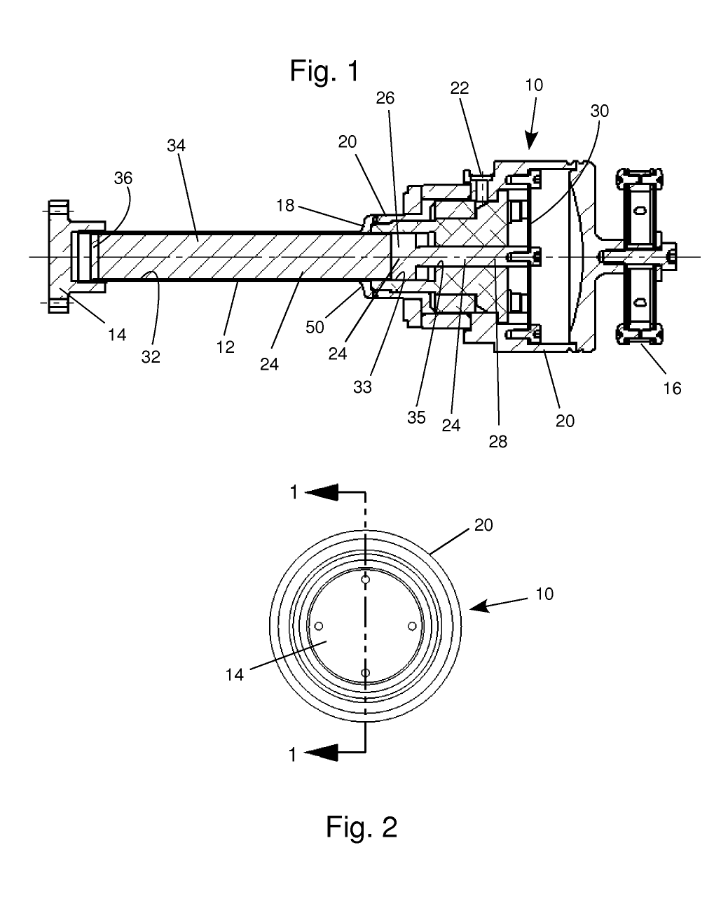

The present invention can be used for either type of Stirling cryocooler configuration and for pulse tube cryocoolers. FIGS. 1 and 2 illustrate an example embodiment of the invention applied to a Stirling cryocooler cold head of the split type configuration. The wave generator is not illustrated because it is not a part of the present invention. Referring to FIGS. 1 and 2, the cold head has a base assembly 10 and a cold finger 12 that is mounted to and extends from the base assembly 10. A cold tip 14 is attached to the distal end of the cold finger 12. The cold finger 12 is an outer, stationary, generally cylindrical tube. A cold finger adapter ring 18 is joined to the cold finger 12 and welded to the casing 20 of the cold head. The method of fabricating the cold finger adapter ring 18 and the cold finger 12 will subsequently be described in more detail. A port 22 is provided for connection to the small tube (not shown) that is connected to the wave generator (not shown). A vibration balancer 16 is attached to the base assembly 10.

A displacer assembly 24 is mounted for reciprocation within the cold head. The displacer assembly 24 has a displacer base 26 with an integral displacer connecting rod 28 that is attached at its distal end to a planar spring 30. The displacer assembly 24 also includes a regenerator housing 32 that is fixed to, and reciprocates with, the displacer base 26. The displacer base 26 reciprocates within a displacer cylinder 33. The displacer connecting rod 28 reciprocates within a displacer rod bore 35. Because FIG. 1 is drawn at a practical scale and because the clearance gap between the exterior surface of the regenerator housing 32 and the interior surface of the cold finger 12 is very small, the two lines representing those two surfaces are indistinguishable in FIG. 1. The regenerator housing 32 is packed with a regenerator material 34. A top cap 36 is fixed to the end of the regenerator housing 32. Both the top cap 36 and the displacer base 26 have a circularly arranged series of spaced holes drilled parallel to the axis so that the working gas is free to pass through and oscillate within the regenerator in the manner that is known to those skilled in this art.

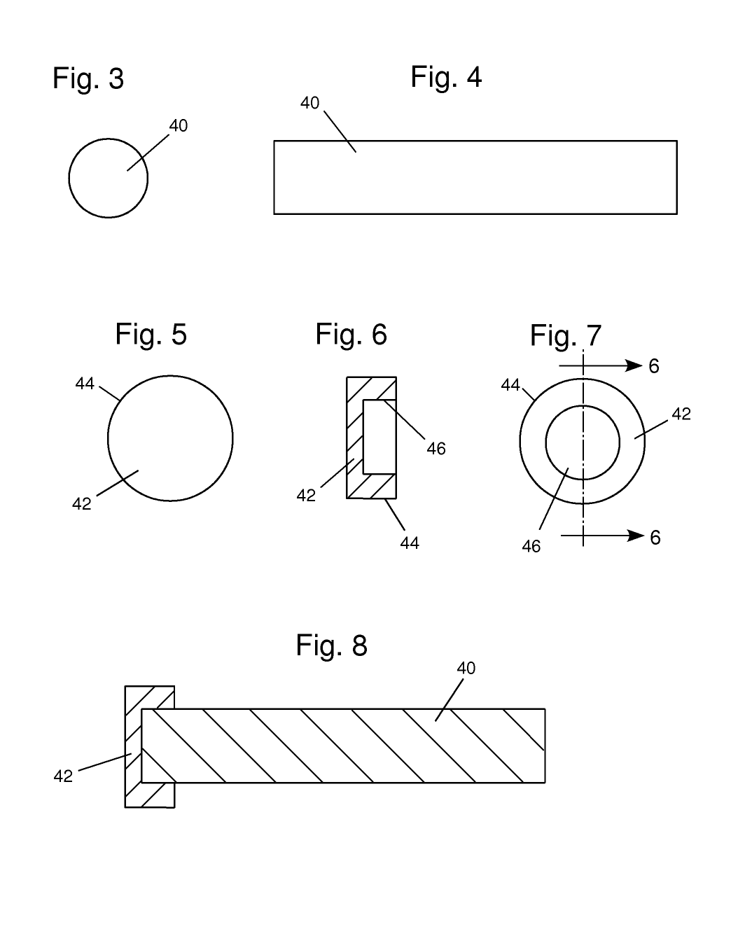

The preferred method for fabricating a cold finger according to the invention for attachment to a cold head base assembly is described with reference to FIGS. 3 through 10. FIGS. 3-8 illustrate intermediate structures and FIGS. 9 and 10 illustrate the completed cold finger. A titanium alloy workpiece 40, which is preferably a titanium alloy rod, is the preferred beginning workpiece. Its exterior surface is machined to form a cylindrical outer surface of the desired diameter.

The outer surface of the titanium workpiece 40 is then nickel plated all 360° around its cylindrical surface at least over one end portion of its cylindrical exterior surface, and more desirably over at least both ends. Most preferably, the titanium workpiece 40 is nickel plated over its entire cylindrical surface along its entire length. The nickel plating may, for example, have a thickness of 14 μm.

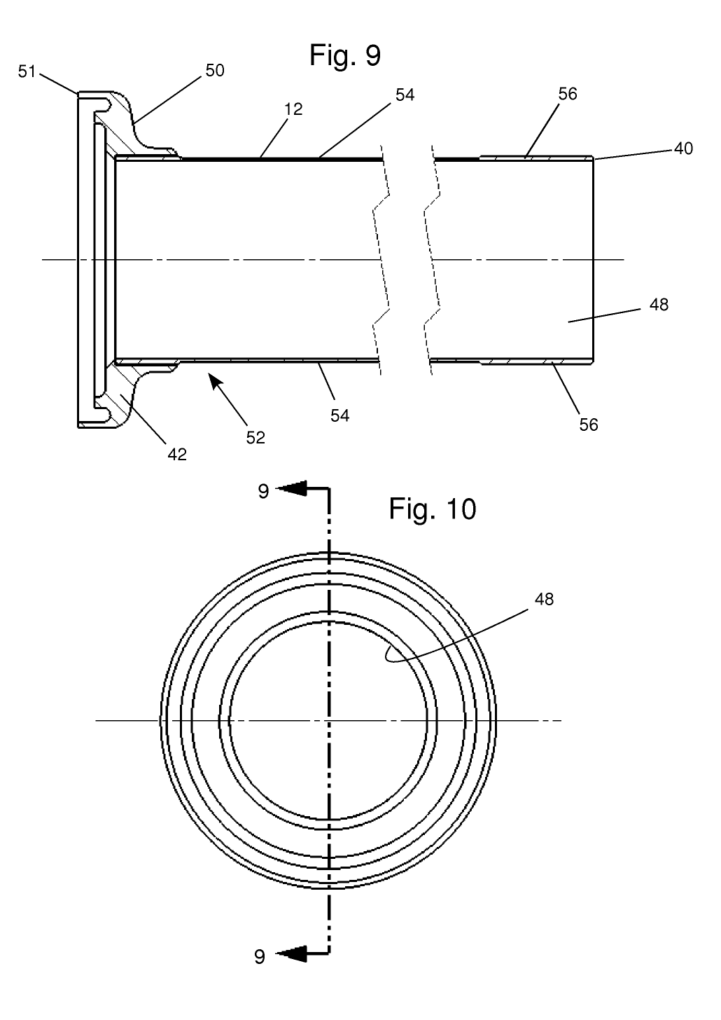

A nickel plated end of the titanium workpiece 40 is then brazed to a stainless steel workpiece 42. The preferred stainless steel workpiece is illustrated in FIGS. 5 through 7. It has a cylindrical outer surface 44 and a countersunk, coaxial, cylindrical bore 46. The bore 46 has an inside diameter that is sized to receive a nickel plated end of the titanium workpiece 40 with a small clearance that facilitates the flow of brazing metal into the clearance gap during the brazing operation. The outside diameter of the stainless steel workpiece 42 must be sufficiently greater than the inside diameter of the bore 46 to provide an interposed annular portion that is sufficiently thick to provide enough mechanical strength. Following the brazing operation, the titanium workpiece 40 and stainless steel workpiece 42 are joined together as illustrated in FIG. 8.

Referring to FIGS. 9 and 10, the joined workpieces form an integral body which is further machined. The brazed stainless steel workpiece 42 is machined to shape it into an adapter ring 50 that will later be welded to the base assembly 10 (FIG. 1). In the preferred form of practicing the method of the invention, the interior of the titanium rod workpiece 40 is machined to form an cylindrical interior surface 48 that is a cold finger tube 52. With the preferred method, the cylindrical inner surface of the titanium workpiece 40 and the cylindrical inner surface of the stainless steel workpiece 42 are machined as one continuous machining operation. The advantage of fabricating the cold finger in this manner is that the alignment problems that are described above are completely eliminated because critical machining is performed only after the titanium component is nickel plated and brazed to the stainless steel component. The joined titanium rod and stainless steel workpiece can be machined as a single piece so conventional machining practices can be used to provide high precision coaxiality of the cylindrical interior of the titanium tube and the cylindrical interior of the adapter ring 50. The adapter ring 50 is desirably machined to form a bell shape, illustrated in FIG. 9, having a wider end distally from the titanium workpiece 40 portion of the cold finger 12. The adapter ring 50 may also be formed with an annular rim 51 which will be welded to (and becomes a part of) the casing 20 of the base assembly 10 of the cold head.

In addition to machining the interior of the titanium workpiece to form it into a cold finger tube and machining the interior and exterior of the stainless steel workpiece to form it into the adapter ring, the exterior of the titanium workpiece is preferably machined to reduce the thickness of the cold finger so that its thermal conductivity is reduced. Referring again to FIG. 9, the thickness of the cold finger tube is reduced by first removing the nickel plating along an intermediate segment 54 of the cold finger 12 but leaving the nickel plating at the thicker end portions 56. Machining is continued deeper along the intermediate segment 54 so that an outer portion of titanium alloy is also removed to reduce the titanium wall diameter and therefore reduce its thickness along the intermediate segment 54 and thereby reduce the conductivity of the titanium cold finger wall. The copper cold tip 14 (FIG. 1) is brazed to the titanium cold finger tube at its end opposite the adapter ring 50.

After fabricating the cold finger 12, an alignment mandrel is used accurately position the cold finger 12 with respect to the base assembly 10 for welding of the adapter ring 50 to the casing 20 of the base assembly 10. When the cold finger 12 is welded to the casing, the displacer cylinder 33 and the displacer rod bore 35 are not yet located inside the base assembly casing 20 because they are assembled after that weld is performed. However, there are two sidewall reference points within the casing that are later used to accurately position the displacer cylinder 33 and the component with the displacer rod bore 35 during their assembly into the base assembly casing 20. One portion of the alignment mandrel slides within and engages the cylindrical interior surface 48 of the cold finger 12 to accurately position the cold finger 12 with respect to the mandrel. Another portion of the mandrel is seated in engagement against the two sidewall reference points within the casing so that the cold finger 12 is accurately positioned by the mandrel with its axis lying where the axes of the displacer cylinder 33 and the displacer rod bore 35, and therefore also the axis of the displacer assembly 24, will be located when the cold head base 10 is assembled. After this positioning of the cold finger 12 on the mandrel and the mandrel in the cold head base, the stainless steel adapter ring 50 is welded to the stainless steel casing 20. This assures that the cold finger 12, including its attached adapter ring 50, is retained on the casing 20 with the axis of the cold finger 12 in coaxial alignment with the displacer cylinder 33 and the displacer connecting rod bore 35. Because stainless steel is relatively easy to weld to stainless steel without deformation or misalignment, the invention provides the advantageous result that a cold finger that is principally formed of a titanium alloy is joined in accurate alignment with the displacer cylinder 33 and displacer rod bore 35 by means of a simple weld.

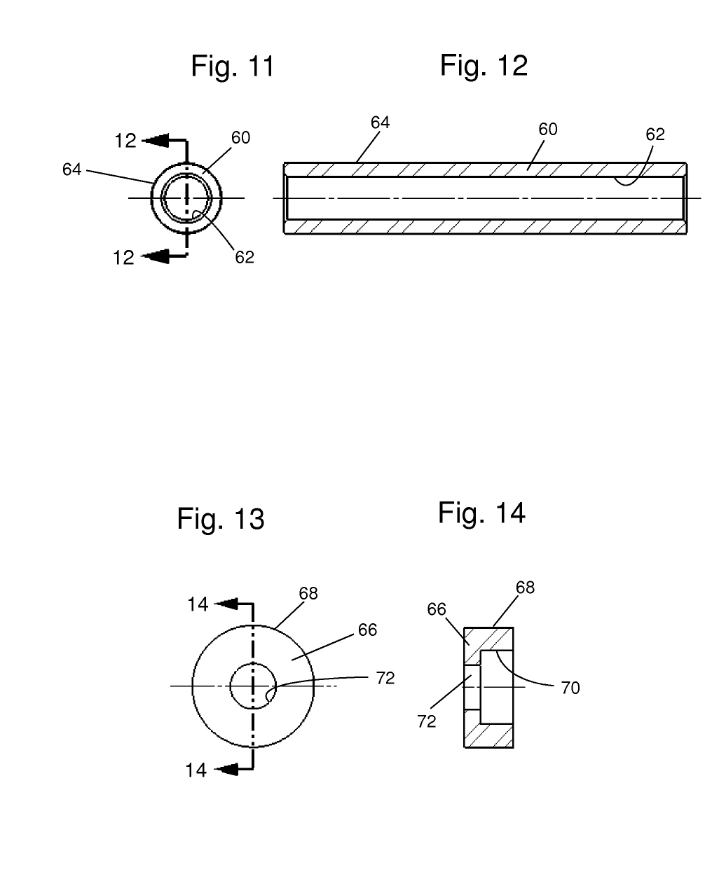

It is possible, although not preferred, to utilize the advantages of the method of the invention in an alternative manner. This alternative is described in connection with FIGS. 11 through 16 which show intermediate work pieces. In this alternative embodiment of the invention, the interior of the titanium workpiece can be machined into a cylindrical surface before the titanium workpiece is joined to the stainless steel workpiece that is formed into the adapter ring. Referring to FIGS. 11 and 12, the interior of a titanium alloy workpiece 60 is machined into an inner cylindrical surface 62 and its exterior is machined into an outer cylindrical surface 64. Referring to FIGS. 13 and 14, the exterior of a stainless steel workpiece 66 is preferably machined into an outer cylindrical surface 68. A countersunk bore 70 is bored or machined into the stainless steel workpiece 66, as is done in the preferred embodiment. If desired, a second coaxial bore 72 may be bored or machined into the stainless steel workpiece 66.

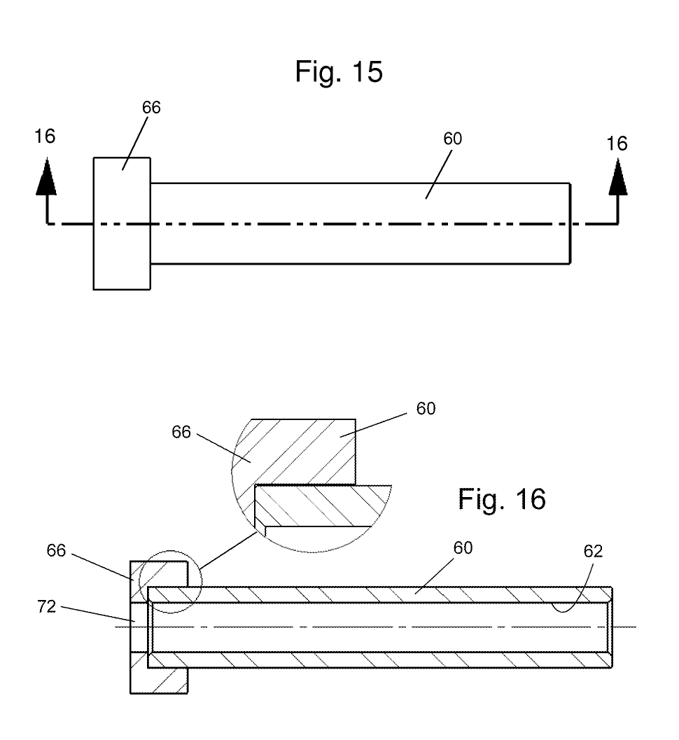

Preferably, at least two end portions and most preferably the entire outer surface of the titanium alloy workpiece 60 is coated with nickel as described above for the preferred embodiment. Referring to FIGS. 15 and 16, the stainless steel workpiece 66 is then brazed to the titanium alloy workpiece 60 to form the structure illustrated in FIGS. 15 and 16 as described above for the preferred embodiment. This alternative embodiment allows the designer at least two options. With the first option, both the second coaxial bore 72 of the stainless workpiece 66 and the inner cylindrical surface 62 of the titanium alloy workpiece 60 can be further machined to a finished diameter. As a second option, the second coaxial bore 72 can not be formed in the stainless steel workpiece 66 until after it is brazed to the titanium alloy workpiece 60. Instead, the titanium alloy workpiece 60 can be further machined to a finished diameter and, as part of the same operation, the second coaxial bore 72 can be machined into the stainless workpiece 66.

Thereafter, the joined workpieces can be machined into the finished cold finger in the manner described for the preferred embodiment. Specifically, with the alternative method of the invention the titanium workpiece 60, which is a tube having an interior cylindrical surface, is machined along an exterior, intermediate segment into a cylindrical surface in a manner that includes removing all of the nickel plating from the intermediate segment and removing a portion of underlying titanium alloy to reduce the diameter of the titanium alloy workpiece in order to reduce the thickness of the wall of a cold finger tube.

This alternative embodiment therefore provides a completed cold finger that is the same as a cold finger fabricated by the preferred embodiment. A mandrel can then be used in the same manner as described above for welding the cold finger to a cold head base assembly.

From the above description of the invention it can be seen that the invention simultaneously solves two problems, the joining problem and the coaxiality problem. The invention joins the titanium alloy portion of the cold finger to a stainless steel cold head casing in a way that is durable and with a material that will not cause outgassing (as an adhesive would) and will not distort or deteriorate during fabrication or use. The invention also joins a tubular titanium alloy portion of the cold finger to a stainless steel cold head in a manner that results in a cold finger that is coaxially aligned with the displacer cylinder and with the cylindrical bore for the displacer connecting rod. The precise coaxial alignment afforded by the invention prevents excessive wear and friction which would retard reciprocation of displacer and lower efficiency or, if sufficient, prevent reciprocation of the displacer.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method for fabricating a cold finger for attachment to a base assembly of a cold head of a Stirling cycle or pulse tube cryocooler, the base assembly including a casing, the method comprising:
(a) machining the exterior surface of a titanium alloy workpiece to form a cylindrical outer surface on the titanium workpiece;
(b) nickel plating at least an end portion of the exterior surface of the titanium workpiece;
(c) brazing the nickel plated end of the titanium workpiece to a stainless steel workpiece;
(d) machining the brazed stainless steel workpiece to form it into an adapter ring for attachment to the base assembly.

2. A method in accordance with claim 1 and further comprising nickel plating the entire outer surface along the entire length of the titanium workpiece.

3. A method in accordance with claim 2 wherein the titanium workpiece is a rod and the method further comprises:
(a) machining an intermediate segment of the titanium workpiece into a cylindrical surface including
(i) removing all of the nickel plating from the intermediate segment; and
(ii) removing a portion of underlying titanium alloy to reduce the diameter of the titanium alloy workpiece in order to provide a reduced thickness wall of a cold finger tube; and
(b) machining the interior of the titanium workpiece and the stainless steel workpiece to form the cold finger tube with a cylindrical interior surface.

4. A method in accordance with claim 3 and further comprising:
(a) mounting an alignment mandrel to the casing in engagement with reference surfaces on the casing and seating the cold finger in engagement with reference surfaces on the cold finger; and
(b) welding the adapter ring of the cold finger to the casing.

5. A method in accordance with claim 3 wherein the method further comprises machining the adapter ring into a bell shape having a wider end distally from the titanium

6. A method in accordance with claim 3 and further comprising brazing a cold tip to the nickel coated titanium workpiece at the opposite end of the titanium workpiece from the adapter ring.

7. A method in accordance with claim 2 wherein the titanium workpiece is a tube having an interior cylindrical surface and the method further comprises:
machining an intermediate segment of the titanium workpiece into a cylindrical surface including
(a) removing all of the nickel plating from the intermediate segment; and
(b) removing a portion of underlying titanium alloy to reduce the diameter of the titanium alloy workpiece in order to provide a reduced thickness wall of a cold finger tube.

8. A method in accordance with claim 7 and further comprising brazing a cold tip to a nickel coated titanium workpiece at the opposite end of the titanium workpiece from the adapter ring.

9. A cold head of a Stirling cycle or pulse tube cryocooler having a casing, the cold head comprising:
(a) a base assembly; and
(b) a cold finger comprising
(i) a titanium alloy cold finger tube having a cylindrical interior and having nickel plated ends;
(ii) a stainless steel adapter ring brazed to one nickel plated end of the cold finger tube and being welded to the casing; and
(iii) a cold tip brazed to the other nickel plated end of the cold finger tube.

10. A cold head in accordance with claim 9 wherein the cold head further comprises: the titanium alloy cold finger tube having a smaller outside diameter between its nickel plated ends to form a thinner tube wall thickness between the nickel plated ends.

11. A cold head in accordance with claim 10 and further comprising a cold tip brazed to a nickel coated end of the titanium workpiece at the opposite end of the titanium workpiece from the adapter ring.

12. A cold head in accordance with claim 9 wherein
(a) the base assembly has a displacer cylinder and a coaxial displacer connecting rod bore through a stationary part of the base assembly;
(b) a displacer is in the displacer cylinder and a displacer connecting rod extends through the bore into connection with a mechanical spring; and
(c) the adapter ring brazed to one nickel plated end of the cold finger tube is in coaxial alignment with the displacer cylinder and the displacer connecting rod bore.

13. A cold head in accordance with claim 12 wherein the cold head further comprises: the titanium alloy cold finger tube having a smaller outside diameter between its nickel plated ends to form a thinner tube wall thickness between the nickel plated ends.

14. A cold head in accordance with claim 13 and further comprising a cold tip brazed to a nickel coated end of the titanium workpiece at the opposite end of the titanium workpiece from the adapter ring.
